(19) United States
(12) Patent Application Publication
(10) Pub. No.: US 2007/0087120 A1
(43) Pub. Date: Apr. 19, 2007

(54) Fluid diffusion layers

(76) Inventors: Donald F. Connors JR., Hudson, NH (US); William F. Grant, Londonderry, NY (US); Thomas J. O'Connor, Chelmsford, MA (US); John R. Gordon, Nanaimo (CA); Raymond C. Loszewski, Windham, NH (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/253,073

(22) Filed: Oct. 18, 2005

(51) Int. Cl. B05D 3/02

(52) U.S. Cl. 427/228

(57) ABSTRACT

Fluid diffusion layers with favorable mechanical, physical and structural properties are prepared for fuel cell electrodes by: impregnating a porous carbonaceous web with a matrix comprising a polymer having pyrrolidone functionality and a high carbon char yield resin, such as activated aramid fiber pulp, lignins, phenolics, benzoxazines and phthalonitriles; and carbonizing the matrix. The polymer is optionally oxidized before carbonizing. The matrix may also include conductive fillers and/or pore formers. The fluid diffusion layers are particularly suitable for use in continuous roll-to-roll MEA processing of GDLs for use in solid polymer electrolyte fuel cells operating at high current densities and/or in highly humidified conditions.

### BACKGROUND OF THE INVENTION

1. Field of the Invention

The present invention relates to methods of manufacture for fluid diffusion layers, in particular for fluid diffusion layers suitable for use as gas diffusion layers for solid polymer electrolyte fuel cells.

2. Description of the Related Art

Solid polymer electrolyte fuel cells employ a membrane electrode assembly (“MEA”), which comprises the solid polymer electrolyte or ion exchange membrane disposed between the two electrodes. Each electrode comprises an appropriate catalyst, preferably located next to the solid polymer electrolyte. The catalyst may, for example, be a metal black, an alloy or a supported metal catalyst such as platinum on carbon. The catalyst may be disposed in a catalyst layer, and a catalyst layer typically contains ionomer, which may be similar to that used for the solid polymer electrolyte (for example, Nafion®). The catalyst layer may also contain a binder, such as polytetrafluoroethylene. The electrode may also contain a substrate (typically a porous, electrically conductive sheet material) that may be employed for purposes of mechanical support and/or reactant distribution, thus serving as a fluid diffusion layer. In the case of gaseous reactants, these layers are referred to as gas diffusion layers (GDL).

The MEA is typically disposed between two plates to form a fuel cell assembly. The plates act as current collectors and provide support for the adjacent electrodes. Flow fields may be incorporated in the current collector/support plates on either side of the MEA for directing reactants across the surfaces of the fluid diffusion electrodes or electrode substrates. Alternatively, flow fields may be integrated into the fluid distribution layers of the electrodes.

The fuel cell assembly is typically compressed to ensure good electrical contact between the plates and the electrodes, in addition to good sealing between fuel cell components. A plurality of fuel cell assemblies may be combined in series or in parallel to form a fuel cell stack.

The fluid distribution layers in such fuel cells may therefore have several functions, typically including: to provide access of the fluid reactants to the catalyst, to provide a pathway for removal of fluid reaction products, to serve as an electronic conductor between the catalyst layer and an adjacent flow field plate, to serve as a thermal conductor between the catalyst layer and an adjacent flow field plate, to provide mechanical support for the catalyst layer, and to provide mechanical support and dimensional stability for the ion-exchange membrane.

Preferably, the fluid distribution layers are thin, lightweight, inexpensive, and readily prepared using mass production techniques (for example, reel-to-reel processing techniques). Materials that have been employed in fluid distribution layers for solid polymer electrolyte fuel cells include commercially available carbonaceous webs, including carbon fiber paper and woven and/or non-woven carbon fabrics. Woven and non-woven carbon fabrics and hydro-entangled felts tend to have more suitable mechanical and/or electrical properties, but contain a relatively large amount of carbon fibers, which is disadvantageous because of increased cost compared to carbon fiber papers. However, the mechanical and/or electrical properties of carbon fiber papers alone may not be adequate to meet all the requirements for fuel cell applications.

Consequently, appropriate fillers and/or coatings have been employed in the art to improve one or more of these properties. For instance, carbon composites can be made from carbon fiber papers impregnated with a suitable matrix, typically containing a carbon-containing resin and optionally carbon and/or graphite particles. The resin is then cured and carbonized leaving behind a substantial amount of carbonization product and resulting in a stiffer, more conductive web.

Phenolic resins have been commonly used in many impregnation applications. U.S. Pat. No. 6,037,073 employs a phenolic resin in its preparation of a combination bipolar plate/diff user component. The combination component is prepared by making and screening an aqueous slurry mixture of carbon fibers (such as chopped or milled carbon fibers of various lengths) and 20-50 wt % phenolic resin powder binder to produce a wet monolith, which is subsequently carbonized at between about 700-1300° C. in an inert environment. A hermetic region on one side of the fluid diffusion layer is then achieved via conventional masking and chemical vapor infiltration (CVI) techniques.

Unfortunately, the carbonized phenolic matrix in such composites tends to be brittle. This characteristic has generally limited the manufacture of GDL material to forming discrete sheets: phenolic-based composites are more susceptible to cracking and failure in roll-to-roll manufacturing processes; complex and costly web fiber blending and bonding cycles have been employed to reduce brittleness; but this undesirably increases manufacturing cost.

Other carbonizable polymers may be considered for use in preparing fluid diffusion layers in a like manner to phenol-formaldehyde resins. Commonly assigned U.S. Pat. No. 6,667,127 describes a method for manufacturing fluid distribution layers by impregnating a porous carbonaceous web with a carbonizable polymer having pyrrolidone functionality, where the pyrrolidone functionality is stabilized against vaporization by the use of an oxidation step prior to carbonization. Fluid diffusion layers incorporating graphite particles in the matrix to further improve its properties (e.g., electrical conductivity) are also described. Unlike processes employing phenolic resins, the method of U.S. Pat. No. 6,667,127 is particularly suitable for continuous GDL manufacture.

Fluid diffusion layers made with polypyrrolidone resin, such as those commercially available from Ballard Material Products Inc. (Lowell, Mass.), have exhibited exemplary performance as GDLs in fuel cell applications at lower current densities. At higher current densities (≧1 A·cm⁻²) and/or under highly humidified conditions, however, cell voltage drops have been observed.

There remains a need for a fluid diffusion layer suitable for fuel cell applications that is amenable to large-scale continuous manufacturing processes, and which exhibits consistent performance at higher current densities and/or relative humidity operation. The present invention fulfils these needs and provides further advantages.

### BRIEF SUMMARY OF THE INVENTION

In one aspect of the present invention, a method of making a fluid diffusion layer comprises impregnating a porous, carbonaceous web with a matrix comprising a polymer having pyrrolidone functionality and a high carbon char yield resin, and carbonizing the matrix. In some embodiments, the method further comprises oxidizing the polymer before carbonizing.

In some embodiments, the porous carbonaceous web is a carbon fiber paper. Non-limiting examples of high char yield resins include activated aramid fiber pulp, lignins, phenolics, benzoxazines and phthalonitriles. In certain embodiments, the resin is a phenolic resin and the polymer having pyrrolidone functionality is polyvinylpyrrolidone (PVP). In further embodiments, the ratio of phenolic resin to PVP in the matrix is less than about 3:1; in other embodiments, the ratio of phenolic resin to polymer in the matrix between about 2:1 and about 1:3.

In certain embodiments, the matrix further comprises a conductive filler and/or a pore former. Non-limiting examples of suitable fillers include carbon and graphite aerogels, particles, nanoparticles, fibers and nanofibers. Similarly, suitable pore formers include acrylic, polyethylene and polypropylene fibers and powders, and methyl cellulose. The matrix composition may be selected such that the bulk density of the carbonized fluid diffusion layer, excluding the web, is ≦0.2 g/cm³.

Fluid diffusion layers made according to the present method are particularly suitable as GDLs for fuel cell electrodes.

These and other aspects of the invention will be evident upon reference to the following detailed description.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of an electrode comprising a fluid diffusion layer for a solid polymer electrolyte fuel cell.

FIG. 2 is a polarization curve showing cell voltage as a function of cell current for a solid polymer electrolyte fuel cell incorporating conventional fluid diffusion layers.

FIG. 3 illustrates polarization curves showing cell voltage as a function of cell current for a series of solid polymer electrolyte fuel cells incorporating fluid diffusion layers made according to embodiments of the present method as cathode GDLs.

### DETAILED DESCRIPTION OF THE INVENTION

In the following description, certain specific details are set forth in order to provide a thorough understanding of the various embodiments of the invention. However, one skilled in the art will understand that the invention may be practiced without these details. In other instances, well-known structures associated with fuel cells and fuel cell stacks, such as plates, manifolds, and reactant delivery systems have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to.”

“Carbon fiber paper” means a non-woven carbon fiber mat. “Carbonization” is defined herein as increasing the proportion of carbon by heating to temperatures of 600° C. or greater in a non-oxidizing environment.

Polymers having pyrrolidone functionality include monomers containing a pyrrolidone functional group. Such monomers are represented by the following general chemical formula: 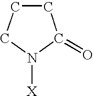
where X represents chemical groups suitable for polymerization, such as for example, alkenyl groups.

Such polymers may be homopolymers of pyrrolidone monomers and copolymers formed by polymerizing two or more monomers, at least one of which provides pyrrolidone functionality. The pendant pyrrolidone rings of the polymer can be substituted or unsubstituted. For example, it may be advisable to employ pyrrolidone rings substituted with alkyl, alkenyl, or other groups. The term “pyrrolidone functionality” means the presence of one or more pendant pyrrolidone rings.

In the present context, “impregnated” means contained within, and the impregnated fluid diffusion layer does not require that all pores or voids are completely filled; in fact, it is specifically contemplated herein that the present fluid diffusion layers are impregnated but may still have substantial porosity. For example, the fluid diffusion layer preferably is at least about 50% porous. In the present context, the web impregnated with a carbonization product will preferably be made by impregnating the web with a carbonizable polymer having pyrrolidone functionality, followed by carbonization. A filler need not “fill” the porous carbonaceous web but may be disposed on a surface of such a web.

Fluid diffusion layers made from carbonaceous webs impregnated with a carbonized polymer having pyrrolidone functionality, such as described in commonly assigned U.S. Pat. No. 6,667,127, have been successfully employed as GDLs in fuel cells, particularly in low current density applications (<1 A·cm⁻²). However, fuel cells employing these GDLs have demonstrated undesirably low cell voltages in some situations under higher current density (≧1 A·cm⁻²) and/or highly humidified conditions (80% to 100% Rh). Without being bound by theory, applicants believe this is due to mass transport losses related to liquid water accumulation in the GDL structure and at the GDL-catalyst interface. In fluid diffusion layers employing PVP, the polymer produces a relatively low carbon char yield after stabilization and carbonization. Carbon and/or graphite particles are typically added to these fluid diffusion layers to increase the carbon content, thermal and electrical conductivity, for example. The resulting structure includes a large proportion of apparent pores, as determined by Hg intrusion porosimetry, in the mean diameter range 50 □m, as well as significant populations in the intermediate (1-10 μm) and small (0.1-1 μm) mean size ranges. Based upon the known composition, optical and scanning electron microscopy, the apparent pore size distributions and in-situ performance characteristics, it was hypothesized that pore size, pore shape (acute, angular or interfacial) and pore distribution were contributing to water droplet formation and retention, resulting in blockage of reactant gases from the catalyst active sites.

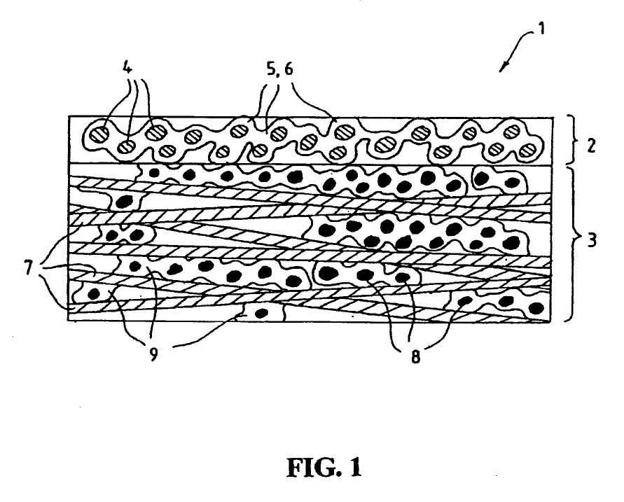

FIG. 1 illustrates an electrode 1 for a typical solid polymer electrolyte fuel cell that includes a fluid diffusion layer prepared using the present method. Electrode 1 comprises catalyst layer 2 and fluid diffusion layer 3. While FIG. 1 shows the catalyst layer 2 and the fluid diffusion layer 3 as distinct layers, they may also overlap to various extents. In this embodiment, catalyst layer 2 comprises carbon-supported catalyst particles 4 along with ionomer 5 and polytetrafluoroethylene (PTFE) binder 6, both of which are dispersed around catalyst particles 4. The use of binder 6 and/or ionomer 5 is optional. Fluid diffusion layer 3 comprises carbon fiber paper 7, filler 8, and carbonized matrix 9, which is dispersed within carbon fiber paper 7 and filler 8 and contains a polymer with pyrrolidone functionality and a high char yield resin. Fluid diffusion layer 3 may optionally include ionomer and/or PTFE binder (not shown). Further, electrode 1 may optionally include a carbon-based sublayer (not shown) between catalyst layer 2 and fluid diffusion layer 3. Such a sublayer may also contain a carbon (for example, graphite or carbon black), ionomer, and/or PTFE, as will be apparent to persons of ordinary skill in the art.

Carbon fiber paper 7 can be conventionally obtained rolls of continuous web (for example, the aforementioned Technical Fibre Products Ltd. materials) and may be used as a porous carbonaceous web. Suitable carbon fiber papers include materials formed from PAN, pitch or rayon precursors, and from other precursors such as polyvinyl alcohol, polyamides and phenolics, provided the overall properties of the papers are suitable for the intended application of the fluid distribution layer. Provided the carbon fiber paper can be carbonized without melting, and preferably compatible with a subsequent stabilization thermal treatment, the selection of a carbon fiber paper is not essential to the present invention; however, carbon fiber selection will influence the full range of properties subsequently produced in the GDL substrate. Persons of ordinary skill in the art will readily be able to select a suitable carbon fiber paper for a given application.

The matrix impregnated into the carbon fiber paper contains a polymer containing pyrrolidone functionality and a higher carbon char yield resin. In some embodiments, the matrix also includes filler that helps to impart desired properties to the fluid diffusion layer. In other embodiments, the matrix further includes a pore former for purposes of controlling the pore structure of the fluid diffusion layer to a further extent as a result of subsequent processing. The matrix also comprises a carrier solvent that is selected to dissolve and/or disperse the other components. In environmentally sensitive applications, the preferred solvent is water; however, other solvents, such as N-methyl-morpholine-N-oxide monohydrate, which can be totally reclaimed and re-used, may also be employed. Where aqueous dispersions are employed, the matrix may optionally include one or more stabilizing agents, such as methylcellulose, for example (methylcellulose is also a fugitive pore-former, as discussed below). The physical properties of the matrix also should be compatible with the desired impregnation method; therefore rheological considerations, for example, may circumscribe the selection of matrix components. Persons of ordinary skill in the art may readily select matrix components that are compatible with a chosen solvent and suitable for the desired application.

Any suitable polymer containing pyrrolidone functionality may be employed in the present method. In some embodiments, the polymer having pyrrolidone functionality is a homopolymer of N-vinyl-2-pyrrolidone or a copolymer of N-vinyl-2-pyrrolidone with one or more ethylenically-unsaturated copolymerizable monomers. In other embodiments, the polymer is polyvinylpyrrolidone (PVP). Suitable such polymers provide an adequate char yield (>10%) on carbonization to impart the desired physical and mechanical properties to the fluid diffusion layer for a given application. In general, a high molecular weight polymer is used in order to increase the concentration of carbon in the mixture and thereby reduce the loss of material during oxidation and carbonization.

In the present method, higher char yield resins are included in the matrix to increase the carbon content, electrical and/or thermal conductivity of the fluid diffusion layer after carbonization, while maintaining an open pore structure desired level of porosity and manufacturability for roll-to-roll factory processing. For example, phenolic resins are employed in some embodiments. It is anticipated that other such resins may be employed in other embodiments, including lignins, phenolic, benzoxazines and phthalonitrile resins or activated aramid fiber pulp. The selection of a given resin will depend on several factors, including the desired carbon content of the fluid diffusion layer and the composition of the matrix. For example, if the matrix is an aqueous dispersion, then the selected resin should be compatible with such systems. Persons of ordinary skill in the art may readily select a suitable higher char yield resin for a given application.

Suitable fillers may be added to the matrix to help impart desired properties to the fluid diffusion layer. In some embodiments, for example, carbon and/or graphite fillers may be added to increase thermal and/or electrical conductivity, and potentially improve mechanical properties, as well. Such fillers may be powders, nanopowders, fibers or nanofibers, for example. Non-particulate fillers of several diameters, lengths and materials can be used. For instance, more than one type of fiber length can be used to substantially vary pore structure in x-y direction, and/or a substantial amount of the fibers may be oriented in the z-direction orientation to obtain desired properties (for example, improved through-plane conductivity). If powders are employed, the particle size is preferably selected such that pores in carbon fiber paper are not unduly blocked yet such that the particles remain supported to some extent in carbon fiber paper.

In other embodiments of the present method, non-particulate filler, such as chopped carbon fibers, is applied directly to the surface of the carbon fiber paper and then covered with the matrix. In subsequent processing steps, the carbonized matrix mechanically binds the filler and carbon fiber paper materials together. In such embodiments, a compaction step may be employed after impregnation of the matrix, to assist in distributing the matrix through the web of the carbon fiber paper. In other embodiments, the matrix may be uniformly, mostly uniformly distributed, or non-uniformly distributed.

In some embodiments, the matrix includes fugitive pore-formers, such as methylcellulose, acrylic, polyethylene microfibers, powders or beads. These materials pyrolyze cleanly during the carbonization step, to form various aspect ratio pores in the matrix of the fluid diffusion layer.

The matrix may be applied to the carbon fiber paper using any conventional impregnation or coating method. After coating, the carrier solvent is dried off. The coated carbon fiber paper is then preferably subjected to an oxidation treatment to stabilize the pyrrolidone-containing polymer and thus maintain the highest possible carbon yield during carbonization. During oxidation and subsequent carbonization, a certain portion of the impregnated pyrrolidone-containing polymer is removed. In embodiments employing PVP, without a suitable stabilizing step, generally most of the impregnated polymer would be volatilized during carbonization. In such embodiments, a typical oxidation treatment involves baking the material for about an hour in air in the range of 200° C. to 300° C., although other equivalent oxidation treatments may be performed instead while still achieving effective stabilization of the PVP polymer. For instance, significantly shorter treatment times might be used with higher temperatures (for example, above 420° C.), or other means of oxidation might be used. The optionally stabilized matrix is then carbonized by heating to temperatures of above 850° C., preferably above 1600° C., in inert or vacuum environments for up to approximately 1 hour, thereby completing the preparation of the fluid diffusion layer.

Those skilled in the art will appreciate that various properties of fluid diffusion layers made according to the present method (including pore structure, wettability, and other mechanical or electrical properties) can be controlled to a certain extent by varying the type of carbon fiber paper and/or by varying the composition of the impregnating matrix. Additionally, the properties of a fluid diffusion layer may be varied somewhat in the thickness direction by applying multiple coats onto the carbon fiber paper using matrices of varied composition.

In another aspect, the present invention provides a method of making a fluid diffusion electrode. The method incorporates the foregoing steps for making a fluid diffusion layer described previously, and further includes applying catalyst to the fluid diffusion layer to form catalyst layer thereon. Preferably, a catalyst mixture would be applied, such as a catalyst mixture comprising catalyst particles along with an ionomer and/or PTFE binder, in the case of an electrode suitable for a solid polymer electrolyte fuel cell, for example.

The selection of catalyst, catalyst layer components, and methods of applying it to the impregnated carbon fiber paper are not essential to the present invention, and persons of ordinary skill in the art may select suitable catalysts and application methods for a desired application.

The following examples have been included to illustrate different embodiments and aspects of the invention but these should not be construed as limiting in any way.

### EXAMPLES

### Comparative Example 1

### Fluid Diffusion Layer

Fluid diffusion layers were prepared as follows. Several samples of carbon fiber paper (Technical Fibre Products Limited, product number 20352B) having a weight per unit area of 17 g/m² and approximately 200 μm thick were selected. The carbon fiber paper was impregnated with an aqueous mixture comprising:

| | |
|---|---|
| Distilled water | 34% |
| Methyl cellulose solution (4% by weight) | 20% |
| 20% PVP solution | 37% |
| Carbon/graphite powder | 9% |

The carbon/graphite powder consisted of 1 part carbon black powder (particle size ˜40 nm) and 4 parts synthetic graphite powder (particle size ˜20-44 μm). The mixture was 18% solids by weight and was prepared by shear mixing the components with a Silverson mixer at 5500 rpm for 15 minutes. The mixture was then applied to the carbon fiber paper by a saturation process followed by fixed-gap sizing and air-drying at ambient temperature. The PVP in the samples were then stabilized by heating to 250° C. in an oxidizing environment for an hour. The stabilized, impregnated carbon fiber paper was then continuously heat treated at a temperature greater than 1000° C. under nitrogen for 6 minutes, followed by furnace heat treatment at a temperature above 1600° C. for an hour.

### Comparative Example 2

### Fluid Diffusion Layer

Samples of fluid diffusion layers were prepared in a like manner to those of Comparative Example 1 except with a matrix containing a blend of about 25% PVP and 75% phenolic resin, as shown below.

| | |
|---|---|
| Distilled water | 55.6% |
| Methyl cellulose solution (4% by weight) | 19.7% |
| 20% PVP solution | 9.2% |
| Phenolic resin | 6.1% |
| Carbon/graphite powder | 9.4% |

### Example 3

### Fluid Diffusion Layer

Samples of fluid diffusion layers were prepared in a like manner to those of Comparative Examples 1 except that the aqueous matrix formulation contained a blend of about 75% PVP, 25% phenolic resin, acrylic powder as an additional pore former and about 50% reduction of the carbon/graphite powder, as shown below.

| | |
|---|---|
| Distilled water | 32.8% |
| Methyl cellulose solution (4% by weight) | 19% |
| 20% PVP solution | 36% |
| Phenolic resin | 2.7% |
| Carbon/graphite powder | 4.7% |
| Acrylic powder (30 μm mean diameter) | 4.8% |

### Example 4

### Fluid Diffusion Layer

Samples of fluid diffusion layers were prepared in a like manner to those of Example 3 except with a matrix formulation, as shown below, containing a blend of about 50% PVP, 50% phenolic resin, an addition of aerogel to the carbon/graphite fill powders, and a 20% reduction in overall solids content. This blend contained no additional pore forming aids in the matrix.

| | |
|---|---|
| Distilled water | 58% |
| Methyl cellulose solution (4% by weight) | 19% |
| 20% PVP solution | 13% |
| Phenolic resin | 3% |
| Carbon/graphite powder | 7% |
| | (17% aerogel carbon) |

### Example 5

### Fluid Diffusion Layer

Samples of fluid diffusion layers were prepared in a like manner and with the same matrix composition as Example 4, except a carbon fiber paper (Technical Fibre Products Limited, product number 20352B) having a weight per unit area of 25 g/m² and approximately 325 micrometers thick was selected. The carbon fiber paper was impregnated with an aqueous mixture comprising:

| | |
|---|---|
| Distilled water | 58% |
| Methyl cellulose solution (4% by weight) | 19% |
| 20% PVP solution | 13% |
| Phenolic resin | 3% |
| Carbon/graphite powder | 7% |
| | (17% aerogel carbon) |

Physical properties of fluid diffusion layers prepared in Comparative Example 1, and Examples 2 thru 5 are summarized in the following table.

TABLE 1
EX-SITU TEST RESULTS

| | Comparative | Comparative | Exam- | Exam- | Exam- |
|---|---|---|---|---|---|
| Property | Example 1 | Example 2 | ple 3 | ple 4 | ple 5 |
| Gurley number: | 30 | 18 | 4.8 | 4.2 | 4.6 |
| through-plane | | | | | |
| (sec) | | | | | |
| Gurley number: | 300 | 83 | 51 | 53 | 23.6 |
| in-plane (sec) | | | | | |
| Taber - MD | 8 | 7.4 | 5.5 | 7.5 | 25 |
| Taber - XMD | 3 | 4.2 | 4.7 | 3.4 | 15 |
| Bulk density of | 0.238 | 0.223 | 0.127 | 0.125 | 0.096 |
| matrix fill | | | | | |
| (g/cc) | | | | | |
| Median pore | 48.5 | — | 36.8 | 41.5 | 29.7 |
| size (μm) | | | | | |
| Total pore area | 33 | — | 34.5 | 55.2 | 36.3 |
| (m²/g) | | | | | |

Gurley number was measured by a Gurley densometer in which 100 cm³ of air is passed through a layer area of 0.1 in² (0.65 cm²) at a pressure of 20 psi (138 kPa). The Taber units were determined according to standard test method ASTM D5342-95. Taber—MD means the stiffness of the material in the machine direction, parallel to the length of the paper roll; Taber—XMD means the stiffniess of the material in the cross machine direction, perpendicular to the length of the paper roll.

Median pore size and total pore area were measured using mercury intrusion porosimetry (MIP), using an Autopore IV 9520 porosimeter (Micromeritics, Norcross, Ga.). Pore size, volume, distribution and total pore area was characterized from the analysis of pressure versus intrusion data using the Washburn equation.

Bulk density was calculated by dividing the sample's area weight by its uncompressed thickness as measured by a micrometer, resulting in a volumetric measure of density, including its pore volume. As used in Table 1, the bulk density of the impregnated matrix was calculated by subtracting the bulk density of the carbon fiber paper from the bulk density of the sample.

As shown in Table 1, the fluid diffusion layers of Examples 3, 4 and 5 demonstrate improved through-plane and in-plane gas permeability, while maintaining both acceptable stiffness for dimensional and mechanical stability and flexibility suitable for continuous manufacturing processes. In addition, the Examples demonstrate trends of lower matrix fill density, smaller mean pore size and higher total pore area.

### Comparative Examples 6 and 7

### MEA Preparation and Fuel Cell Operation

MEAs were prepared from fluid diffusion layers of Comparative Examples 1 and 2, as follows.

### Comparative Example 6

Anode GDL: a carbonized paper substrate (Ballard Material Products, product number DEV80003), was coated with 20 g/m² of a uniformly mixed blend of KS75 graphite powder, PTFE solution, methyl cellulose solution and distilled or deionized water to form a carbon sublayer. The carbon sublayer had the following composition by weight:

| | |
|---|---|
| KS75 graphite powder | 9.7 |
| 60% PTFE Solution | 2.2 |
| 4% Cellulose solution | 48.7 |
| Water | 39.3 |

After air drying the coated GDL was sintered at a temperature not to exceed 420° C. for a minimum of 10 minutes.

Cathode GDL: the cathode GDL was prepared as described for the anode GDL, above, except that a fluid diffusion layer of Comparative Example 1 was coated with 5 g/m² of carbon sublayer mixture.

Catalyst coated membrane: Gore PRIMEA Series 5510, 0.4 mg/cm2 Pt/0.4 mg/cm2, 25 μm thickness.

Bonding conditions: The GDL layers were assembled against each side of the CCM, but were not bonded.

### Comparative Example 7

An MEA was prepared in a like manner to the MEA of Comparative Example 6 except that the cathode GDL was prepared from a fluid diffusion layer of Comparative Example 2.

The MEAs were assembled in a commercially available 50 cm² test cell, conditioned to fully hydrate and activate the catalyst-coated membrane using fuel cell industry accepted procedures, and tested for beginning of life performance capability. The test conditions were as follows:

Test Conditions

| | |
|---|---|
| Fuel/oxidant | hydrogen/air |
| Reactant pressure | 0.5 barg |
| Stoichiometry | 1.3 fuel, 2.0 oxidant |
| Humidification | 100% Rh at 70° C. inlet |
| | temperature |
| Cell operating temperature | 80° C. |

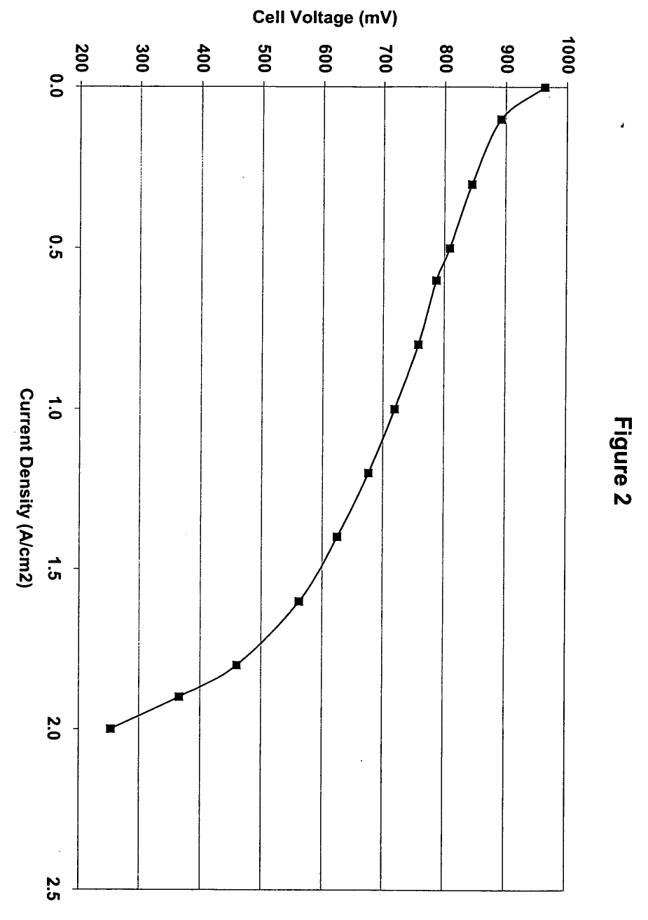

The resulting polarization curve for Comparative Example 6 is shown in FIG. 2. Comparative Example 7 demonstrated similar performance (see Table 2.).

### Examples 8-10

### MEA Preparation and Fuel Cell Operation

MEAs were prepared in a like manner to the MEA of Comparative Example 6 except as indicated below.

Example 8: the cathode GDL was prepared from a fluid diffusion layer of Example 3.

Example 9: the cathode GDL was prepared from a fluid diffusion layer of Example 4.

Example 10: the cathode GDL was prepared from a fluid diffusion layer of Example 5.

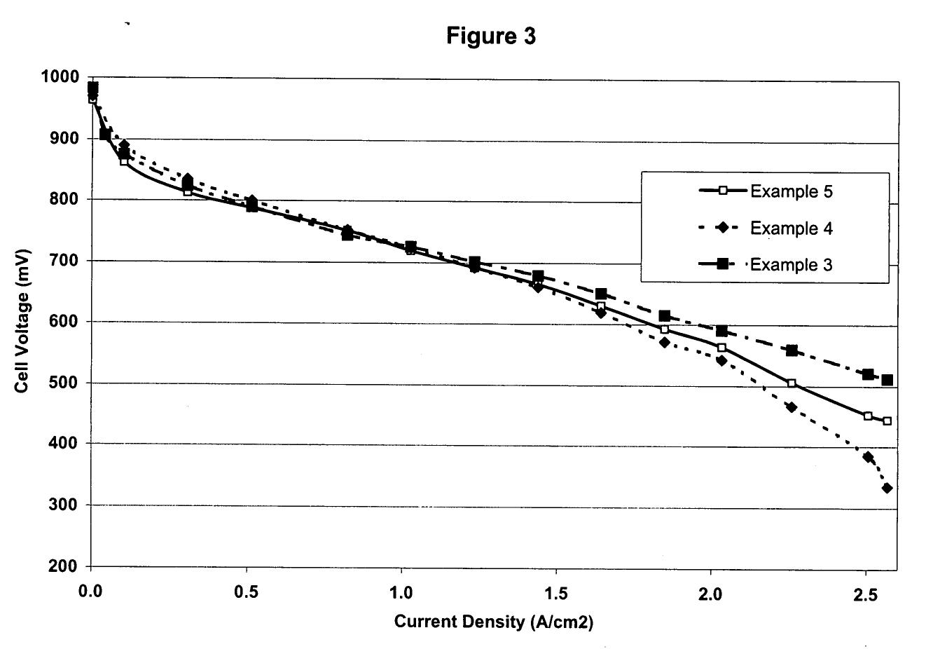

The MEAs for each of Examples 8-10 were assembled and tested for beginning of life performance capability as described in Comparative Examples 6 and 7, under the same test conditions. The resulting polarization curves are shown in FIG. 3. Table 2 presents MEA performance data at selected points from FIGS. 2 and 3.

TABLE 2
Performance Comparison

| | Comparative | Comparative | | | Exam- |
|---|---|---|---|---|---|
| Property | Example 1 | Example2 | Example 3 | Example 4 | ple 5 |
| mV @ | 803 | 787 | 790 | 800 | 785 |
| 0.5 A/cm² | | | | | |
| mV @ | 725 | 702 | 727 | 712 | 725 |
| 1 A/cm² | | | | | |
| mV @ | 568 | 600 | 670 | 654 | 650 |
| 1.5 A/cm² | | | | | |
| mV @ | <300 | 350 | 593 | 550 | 570 |
| 2 A/cm² | | | | | |

As clearly shown in FIGS. 2 and 3 and Table 2, the fuel cells employing MEAs of Examples 3, 4 and 5 demonstrate markedly improved operation at higher current densities and under highly humidified conditions. The data for Examples 8-10 further demonstrate that the observed high current density performance can be achieved through alternate matrix additions and starting carbon fiber papers. The data for Comparative Examples 1 and 2 indicates less than desirable high current density performance, even in fluid diffusion layers having a 3:1 ratio of phenolic resin to PVP. This suggests that simply increasing the carbon matrix fraction of the substrate is ineffectual in achieving significant high current density performance. Applicants have found that fluid diffusion layers having a ratio of phenolic resin to PVP of less than 3:1 exhibit improved performance.

Comparing the data from Table 1 with FIG. 3, improved fuel cell performance was demonstrated for fluid diffusion layers (Examples 3-5) with total filled matrix bulk densities of 0.127 g/cm³ and less. Again, without being bound by theory, applicants believe that the improved performance relates to combined effects from increased carbon content created by the addition of the higher carbon char yield resin, in combination with carbon additives and decreased matrix fill bulk density. Similar performance is predicted for fluid diffusion layers having total filled matrix bulk densities of ≦0.2 g/cm³.

All of the above U.S. patents, U.S. patent application publications, U.S. patent applications, foreign patents, foreign patent applications and non-patent publications referred to in this specification and/or listed in the Application Data Sheet, are incorporated herein by reference in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

We claim:

1. A method of making a fluid diffusion layer comprising:
Impregnation of a porous, carbonaceous web with a matrix comprising a polymer having pyrrolidone functionality and a resin selected from the group consisting of activated aramid fiber pulp, lignins, phenolics, benzoxazines and phthalonitriles;
and carbonizing the matrix.

2. The method of claim 1 wherein the porous carbonaceous web is a carbon fiber paper comprising carbon fibers and a binder.

3. The method of claim 1 wherein the polymer is polyvinylpyrrolidone.

4. The method of claim 1 wherein the resin is a phenolic resin.

5. The method of claim 1 wherein the resin is a phenolic resin and the ratio of phenolic resin to polymer in the matrix is less than about 3:1.

6. The method of claim 1 wherein the resin is a phenolic resin and the ratio of phenolic resin to polymer in the matrix between about 2:1 and about 1:3.

7. The method of claim 1 wherein the matrix further comprises at least one conductive filler.

8. The method of claim 7 wherein the at least one conductive filler is selected from the group consisting of carbon and graphite aerogels, particles, nanoparticles, fibers and nanofibers.

9. The method of claim 7 wherein the at least one conductive filler comprises carbon nanoparticles.

10. The method of claim 7 wherein the at least one conductive filler comprises graphite particles.

11. The method of claim 7 wherein the at least one conductive filler comprises a carbon aerogel.

12. The method of claim 1 wherein the matrix further comprises a pore former.

13. The method of claim 12 wherein the pore former is selected from the group consisting of acrylic, polyethylene and polypropylene fibers and powders, and methyl cellulose.

14. The method of claim 12 wherein the pore former comprises acrylic powder.

15. The method of claim 1 wherein the bulk density of the carbonized fluid diffusion layer, excluding the web, does not exceed 0.2 g/cm³.

16. The method of claim 1 wherein the carbonizing is performed in an inert atmosphere at a temperature above about 850° C.

17. The method of claim 1, further comprising oxidizing the polymer before carbonizing.

18. The method of claim 17 wherein the polymer is polyvinylpyrrolidone and the oxidizing step comprises heating the polymer in an oxidizing atmosphere at a temperature below 420° C. before carbonizing.

19. The method of claim 1 wherein the fluid diffusion layer is a GDL for a fuel cell electrode.
